(19) United States
(12) Patent Application Publication
(10) Pub. No.: US 2010/0229437 A1
(43) Pub. Date: Sep. 16, 2010

(54) FRAME ASSEMBLY FOR A DISPLAY BIN

(76) Inventor: Earl David Forrest, Asheboro, NC (US)

Correspondence Address: Carlson, Gaskey & Olds/Masco Corporation, 400 West Maple Road, Suite 350, Birmingham, MI, 48009, US

(21) Appl. No.: 12/403,489

(22) Filed: Mar. 13, 2009

(51) Int. Cl. G09F 15/02; G09F 15/00; A47B 95/02

(52) U.S. Cl. 40/606.08; 40/606.01; 16/110.1

(57) ABSTRACT

An example frame assembly is configured to hold a display board relative to a bin. The assembly includes a frame establishing an opening and a hooked portion establishing a groove. The hooked portion is configured to extend into an interior of the bin when a portion of the bin is received within the groove. A locking feature is configured to engage a corresponding locking feature. A display board is held relative to the bin when the portion of the bin is received within the groove and the locking feature engages the corresponding locking feature such that the opening provides a path for viewing the display board.

### BACKGROUND

This application relates generally to a frame assembly for securing a display board relative to a display bin.

Many establishments, especially retail establishments, organize products using large display assemblies that include multiple bins. Customers move the bins to access products within that bin. Some bins are similar to cabinet drawers and include a face that slides with the bin to provide access to the product. Other bins include a hinged face that tips out toward the customer to provide access. The faces of some bins are clear, which allows customers to view the quantity and type of products within the bin.

The bins hold products such as cabinet pulls, hinges, and handles. In some examples, the same type of product that is held within the bin is mounted to an outer face of the bin so a customer can easily determine the type of product contained within that particular bin and view the product in a mounted condition. A customer viewing the display assembly eventually may choose a product based on the products mounted to the outer faces of the bins within that display assembly.

As known, customers influence the aesthetics of a room by changing the appearance of the mounting surface, the type of product, or both. Although existing bins display the products in the mounted condition, customers often intend to mount the products to a surface that differs substantially from the face of the bin. For example, a customer may visit the retail establishment to purchase a pull that they intend to mount to a wooden cabinet within their home. Within the retail establishment, however, the customer sees that product mounted to a clear plastic face of the display bin. Displaying the pull within the retail establishment on a mounting surface that differs substantially from the customer's desired mounting surface inhibits the ability of the customer to visualize the aesthetic impact of that pull within their home. This can negatively impact product sales. Some bins include wooden faces instead of clear plastic, but these faces are not easily changed to adapt to changing customer tastes.

### SUMMARY OF THE INVENTION

An example frame assembly is configured to hold a display board relative to a bin. The assembly includes a frame establishing an opening and a hooked portion establishing a groove. The hooked portion is configured to extend into an interior of the bin when a portion of the bin is received within the groove. A locking feature is configured to engage a corresponding locking feature. A display board is held relative to the bin when the portion of the bin is received within the groove and the locking feature engages the corresponding locking feature such that the opening provides a path for viewing the display board.

An example bin assembly includes a bin wall of a display bin moveable between a first position and a second position. The display bin is configured to hold at least one product that is more accessible when the bin wall is in the first position than when the bin wall is in the second position. The example bin assembly also includes a display board and a frame moveable between an engaged position with the bin wall and a disengaged position. The display board is visible through an opening established in the frame. The display board is held relative to an outwardly facing surface of the display bin when the frame is in the engaged position.

An example method of holding a display board adjacent to a bin includes positioning a display board between a bin and a frame, hanging the frame from the bin, and engaging a locking feature on the frame with a locking feature on the bin.

These and other features of the present invention can be best understood from the following specification and drawings, the following of which is a brief description.

### BRIEF DESCRIPTION OF THE DRAWINGS

FIG. 1 shows a perspective view of an example display bin assembly holding a plurality of products.

FIG. 2 shows a section view through line 2-2 of the FIG. 1 display bin without the plurality of products.

FIG. 3 shows a perspective view of another example bin assembly.

FIG. 4 shows an example display bin unit.

### DETAILED DESCRIPTION

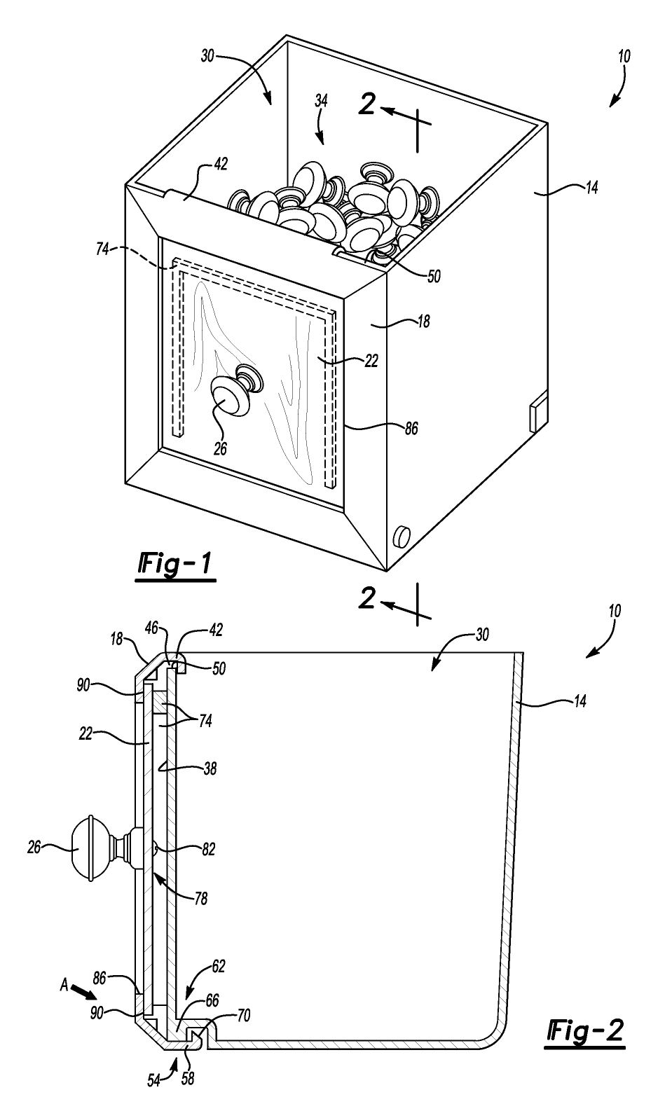

Referring to FIGS. 1 and 2, an example bin assembly 10 includes a bin 14, a frame assembly 18, a display board 22, and a pull 26. The bin assembly 10 defines an interior area 30 used for storing products 34, such as products offered for sale within a retail establishment. In this example, the pull 26 is the same type of product as the products 34 stored within the interior area 30. The pull 26 is mounted to the display board 22 and faces in an outward direction away from the bin 14 such that a customer looking at the bin 14 can see the pull 26 and the display board 22. The products 34 stored within the interior area 30 are typically hidden from the customer's view by the display board 22.

In this example, the display board 22 is a piece of stained wood. In other examples, the display board 22 is entirely a polymer material, a laminated board, etc. The specifications of the display board 22, such as color, material, etc., can be changed to reflect different mounting environments for the pull 26. Accordingly, even though a customer is within the retail establishment, the customer is able to see the pull 26 mounted adjacent to the display board 22 closely resembling the customer's desired mounting surface.

The example frame 18 is moveable between an engaged position with an outer face 38 of the bin 14 and a disengaged position. In the engaged position, the frame 18 holds the display board 22 against the outer face 38. In the disengaged position, at least a portion of the frame 18 is moved away from the outer face 38 enough to enable swapping the display board 22 with another display board.

In this example, one end of the frame 18 includes a hooked portion 42 that establishes a groove 46 configured to receive an upper edge portion 50 of the outer face 38. An opposing end of the frame 18 includes a locking feature 54, which, in this example, is a multitude of tabs 58. The bin 14 includes a corresponding locking feature 62, which is a downwardly extending rib 66 in this example.

To move the example frame 18 from the disengaged position to the engaged position, the hooked portion 42 is first hung from the outer face 38. The tabs 54 are then moved toward the outer face 38 in direction A. Contact with the rib 66 flexes the tabs 54 downward until a raised area 70 of the tabs 54 move past the rib 66. Once past the rib 66, the tabs 54 flex back and the raised area 70 limits movement of the frame 18 away from the bin 14. Flexing the tabs 54 away from the rib 66 enables the frame 18 move away from the bin 14 to the disengaged position. The frame 18, in this example, is a molded polymer material enabling flexing the tabs 54.

The display board 22 is typically positioned between the outer face 38 of the bin 14 and the frame 18 when the frame 18 is in the engaged position. In this example, a spacer 74 holds the display board 22 away from the outer face 38, which creates a cleared area 78 between the outer face 38 and the display board 22. The cleared area 78 accommodates a fastener 82 protruding from the backside of the display board 22. In this example, the fastener 82 helps secures the pull 26 to the display board 22.

The bin 14 is a molded polymer bin and includes the spacer 74 and the rib 66; i.e., the spacer 74 and rib 66 are molded together with the bin 14 as a monolithic component. In another example, the bin 14 is a wooden bin, and the spacer 74, the rib 66, or both are separate components secured to the bin 14 with an adhesive.

The example frame 18 generally defines a rectangular opening 86. When the frame 18 is in the engaged position, the customer can view the display board 22 and the pull 26 through the opening 86. The opening 86 thus provides a view path.

In this example, the frame 18, the opening 86, the outer face 38, and the display board 22 each have generally rectangular profile. Other examples utilize different profiles. Notably, the width of the example opening 86 is slightly smaller than the display board 22. That is, the display board 22 extends laterally further than the opening 86, which provides some overlap between the frame 18 and the display board 22 at areas 90. The frame 18 contacts the display board 22 at these areas 90 to hold the position of the display board 22 relative to the bin 14 and the frame 18 when the frame 18 is in the engaged position.

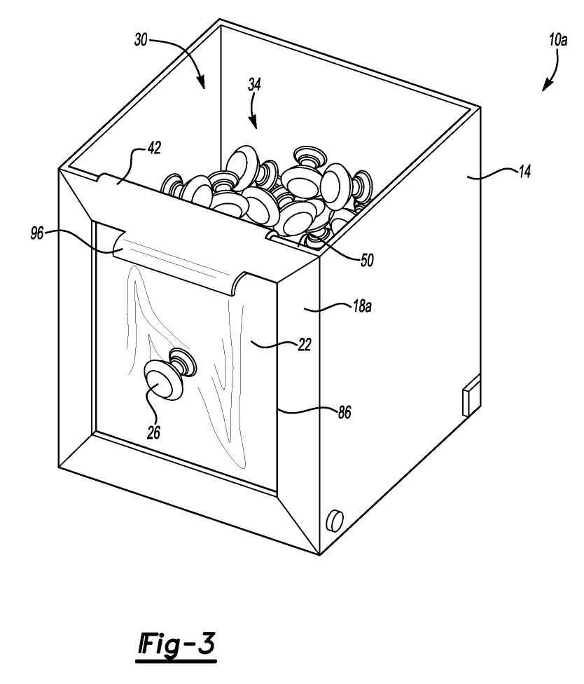

In the example bin assembly 10, the customer moves the pull 26 to move the bin 14 to a position where the customer can access the products 34 within the interior area 30. In another example bin assembly 10a (FIG. 3) a handle 96 extends from the frame 18. The customer uses the handle 96, rather than the pull 26, to move the bin to a position where the customer can access the products 34 within the interior area 30. The handle 96 is molded together with the frame 18 in one example, which reduces potential labor costs associated with securing the handle 96 to the frame 18.

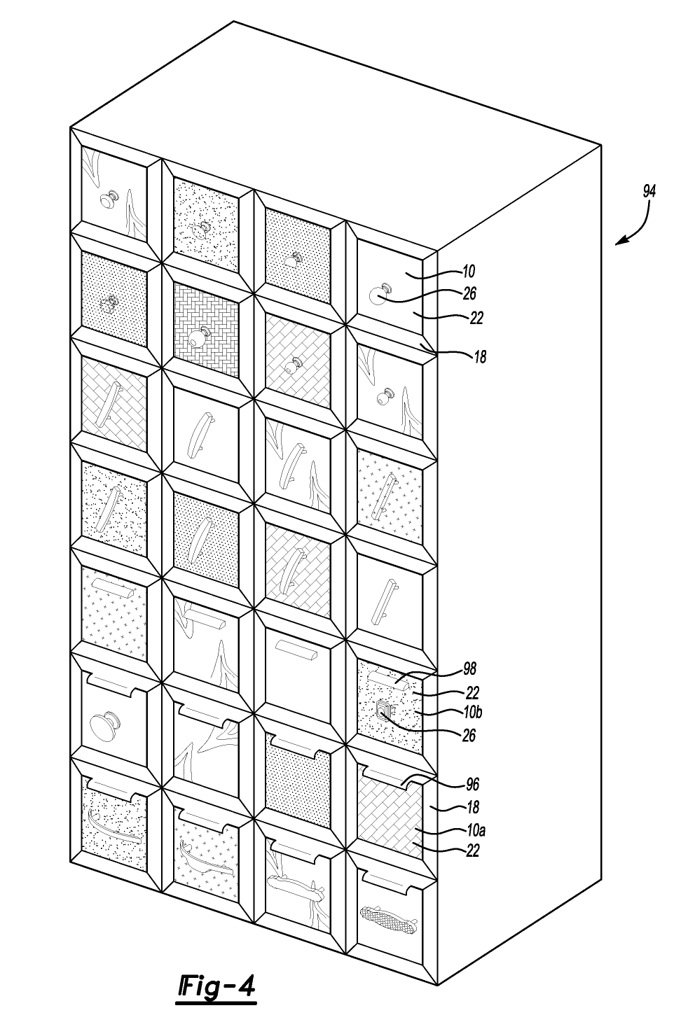

Referring now to FIG. 4 with continuing reference to FIGS. 1 and 3, a display unit 94 includes a plurality of bin assembly 10 and a plurality of the bin assembly 10a. In this example, each bin assembly 10 presents different mounting combinations of the pull 26 and the display board 22 to the customer viewing the unit 94. The frame 18 provides a visual barrier that separates the display board 22 from an adjacent display board.

The example display unit 94 also includes a multiple of a bin assembly 10b each having a handle 98 secured directly to the display board 22. If the bin assembly 10b includes a pull 26, the handle 98 is secured to the display board 22 separate from the pull 26.

Incorporating the handles 96 and 98 into the display bin assemblies 10a and 10b enables the customer to access the products 34 using the appropriate one of the handles 96 and 98 rather than the pull 26 mounted to the display boards 22 and 22.

Although this example discloses the pull 26 mounted to the display board 22, a person skilled in the art having the benefit of this disclosure would be able to apply the inventive display bin to other types of products and environments to achieve a desired result. In some examples, a hinge, handle, or other type of product is mounted to the display board 22. In still other examples, no product 34 is mounted to the display board 22.

In some examples, the handles 96 and 98 are incorporated into bin assemblies 10a and 10b that contain low profile products 34 or no product 34 mounted to the display board 22. The handles 96 and 98 provide the customer with a handhold for moving the bin assemblies 10a and 10b in such examples.

A feature of this invention is facilitating the exchange of a display board with another display board. Another feature of this invention includes the ability to display products adjacent various types of display boards. Yet another feature of this invention is displaying product mounted adjacent to a particular type of material without manufacturing the entire bin from that material.

Although an embodiment of this invention has been disclosed, a worker of ordinary skill in this art would recognize that certain modifications would come within the scope of this invention. For that reason, the following claims should be studied to determine the true scope and content of this invention.

I claim:

1. A frame assembly configured to hold a display board relative to a bin, comprising:
a frame establishing an opening;
a hooked portion establishing a groove, the hooked portion configured to extend into an interior of the bin when a portion of the bin is received within the groove; and
a locking feature configured to engage a corresponding locking feature, wherein a display board is held relative to the bin when the portion of the bin is received within the groove and the locking feature engages the corresponding locking feature such that the opening provides a path for viewing the display board.

2. The frame assembly of claim 1, wherein the groove receives an upper edge portion of an outwardly facing wall of the bin.

3. The frame assembly of claim 2, wherein the corresponding locking feature is a rib on a lower portion of the bin.

4. The frame assembly of claim 3, wherein the rib is a downwardly facing rib.

5. The frame assembly of claim 1, wherein the locking feature on the frame comprises at least one of a tab or an aperture.

6. The frame assembly of claim 1, wherein the frame is configured to contact the perimeter of the display board.

7. The frame assembly of claim 1, wherein the frame comprises a handle.

8. A bin assembly, comprising:
a bin wall of a display bin moveable between a first position and a second position, the display bin configured to hold at least one product that is more accessible when the bin wall is in the first position than when the bin wall is in the second position;
a display board; and
a frame moveable between an engaged position with the bin wall and a disengaged position, the display board visible through an opening established in the frame holding the display board relative to an outwardly facing surface of the display bin when the frame is in the engaged position.

9. The bin assembly of claim 8, including a pull mounted to the display board.

10. The bin assembly of claim 9, wherein the at least one product is the same as the pull.

11. The bin assembly of claim 8, including a spacer that limits movement of the display board toward the bin when the frame is in the engaged position.

12. The bin assembly of claim 11, including a pull mounted to the display board with a fastener extending through the display board, wherein the spacer establishes clearance between the display board and the bin for accommodating the fastener.

13. The bin assembly of claim 8, wherein an outer profile of the frame and an outer profile of the display board are rectangular, the frame extending laterally further than the display board.

14. The bin assembly of claim 8, wherein the opening has a rectangular profile, the display board extending laterally further than the opening.

15. The bin assembly of claim 8, wherein the frame contacts an outer periphery of the display board when the frame is in the engaged position.

16. The bin assembly of claim 8, wherein the frame hangs from an upper edge of the bin when the frame is in the engaged position.

17. The bin assembly of claim 8, wherein the frame comprises a handle configured to move the bin wall between the first position and the second position.

18. A method of holding a display board adjacent to a bin, comprising:
positioning a display board between a bin and a frame;
hanging the frame from the bin; and
engaging a locking feature on the frame with a locking feature on the bin.

19. The method of claim 18, wherein the frame comprises a hook for hanging the frame.

20. The method of claim 19, wherein the frame establishes an opening for viewing the display board.
